(19) United States
(12) Patent Application Publication
(10) Pub. No.: US 2024/0405367 A1
(43) Pub. Date: Dec. 5, 2024

(54) SECONDARY BATTERY

(71) Applicant: MURATA MANUFACTURING CO., LTD., Kyoto (JP)

(72) Inventors: Ami ONUMA, Kyoto (JP); Takeo ASANUMA, Kyoto (JP); Yosuke KONO, Kyoto (JP); Atsushi OUKI, Kyoto (JP); Masumi FUKUDA, Kyoto (JP)

(21) Appl. No.: 18/805,072

(22) Filed: Aug. 14, 2024

Related U.S. Application Data
(63) Continuation of application No. PCT/JP2023/010588, filed on Mar. 17, 2023.

(30) Foreign Application Priority Data
Mar. 30, 2022 (JP) 2022-056758

(51) Int. Cl. H01M 50/443; H01M 10/0525; H01M 50/105; H01M 50/178; H01M 50/417; H01M 50/431; H01M 50/451; H01M 50/491

(52) U.S. Cl. CPC H01M 50/443; H01M 10/0525; H01M 50/105; H01M 50/178; H01M 50/417; H01M 50/431; H01M 50/451; H01M 50/491

(57) ABSTRACT

A secondary battery includes a positive electrode, a negative electrode, a separator, and an electrolytic solution. The separator is disposed between the positive electrode and the negative electrode. The positive electrode includes primary particles as a positive electrode active material. The separator includes a porous layer and a covering layer. The covering layer is disposed between the porous layer and the positive electrode. The covering layer includes insulating particles. The insulating particles each have a major axis and a minor axis. An average particle size of the primary particles is greater than or equal to 100 nm and less than or equal to 2120 nm. A ratio of an average length of the respective minor axes of the insulating particles to the average particle size is greater than or equal to 0.22 and less than or equal to 1.00.

### CROSS SECTION OF RELATED APPLICATIONS

The present application is a continuation of PCT patent application no. PCT/JP2023/010588, filed on Mar. 17, 2023, which claims priority to Japanese patent application no. 2022-056758, filed on Mar. 30, 2022, the entire contents of which are incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, a separator, and an electrolytic solution. A configuration of the secondary battery has been considered in various ways.

Specifically, a positive electrode plate and a negative electrode plate are stacked with a separator interposed therebetween. A heat-resistant layer including inorganic oxide particles (flaky particles) is disposed between the positive electrode plate and the separator. The inorganic oxide particles each have a first principal face, a second principal face, and a mesopore. The inorganic oxide particles are each so oriented that respective normal directions of the first principal face and the second principal face conform to a direction in which the positive electrode plate and the negative electrode plate are stacked.

### SUMMARY

The present technology relates to a secondary battery.

Although consideration has been given in various ways regarding a configuration of a secondary battery, a battery characteristic of the secondary battery is not sufficient yet. Accordingly, there is room for improvement in terms thereof.

It is desirable to provide a secondary battery that makes it possible to achieve a superior battery characteristic.

A secondary battery according to an embodiment of the present technology includes a positive electrode, a negative electrode, a separator, and an electrolytic solution. The separator is disposed between the positive electrode and the negative electrode. The positive electrode includes primary particles as a positive electrode active material. The separator includes a porous layer and a covering layer. The covering layer is disposed between the porous layer and the positive electrode. The covering layer includes insulating particles. The insulating particles each have a major axis and a minor axis. An average particle size of the primary particles is greater than or equal to 100 nm and less than or equal to 2120 nm. A ratio of an average length of the respective minor axes of the insulating particles to the average particle size is greater than or equal to 0.22 and less than or equal to 1.00.

Each of the “average particle size” and the “average length” is calculated based on an observation result (an electron microscope photograph) of a section of the secondary battery. The observation is performed with use of an electron microscope. Details of the calculation procedures will be described later.

According to the secondary battery of an embodiment of the present technology, the separator including the porous layer and the covering layer is disposed between the positive electrode and the negative electrode. The positive electrode includes the primary particles as the positive electrode active material. The covering layer disposed between the porous layer and the positive electrode includes the insulating particles. The insulating particles each have the major axis and the minor axis. The average particle size of the primary particles is greater than or equal to 100 nm and less than or equal to 2120 nm. The ratio of the average length of the respective minor axes of the insulating particles to the average particle size is greater than or equal to 0.22 and less than or equal to 1.00. Accordingly, it is possible to achieve a superior battery characteristic.

Note that effects of the present technology are not necessarily limited to those described herein and may include any of a series of effects in relation to the present technology.

### BRIEF DESCRIPTION OF THE FIGURES

FIG. 1 is a perspective view of a configuration of a secondary battery according to one embodiment of the present technology.

FIG. 2 is a sectional view of a configuration of a battery device illustrated in FIG. 1.

FIG. 3 is a plan view of a configuration of a positive electrode illustrated in FIG. 2.

FIG. 4 is a plan view of a configuration of a negative electrode illustrated in FIG. 2.

FIG. 5 is an enlarged diagram schematically illustrating a configuration of the battery device after a heating test.

FIG. 6 is a diagram schematically illustrating a configuration of an insulating particle.

FIG. 7 is a perspective view for describing a method of manufacturing the secondary battery.

FIG. 8 is a block diagram illustrating a configuration of an application example of the secondary battery.

### DETAILED DESCRIPTION

The present technology is described below in further detail including with reference to the drawings according to an embodiment.

A description is given first of a secondary battery according to an embodiment of the present technology.

The secondary battery to be described here is a secondary battery in which a battery capacity is obtained through insertion and extraction of an electrode reactant, and includes a positive electrode, a negative electrode, a separator, and an electrolytic solution.

In the secondary battery, a charge capacity of the negative electrode is greater than a discharge capacity of the positive electrode. In other words, an electrochemical capacity per unit area of the negative electrode is set to be greater than an electrochemical capacity per unit area of the positive electrode. This is to prevent precipitation of the electrode reactant on a surface of the negative electrode during charging.

Examples are given below of a case where the electrode reactant is lithium. A secondary battery in which the battery capacity is obtained through insertion and extraction of lithium is what is called a lithium-ion secondary battery. In the lithium-ion secondary battery, lithium is inserted and extracted in an ionic state.

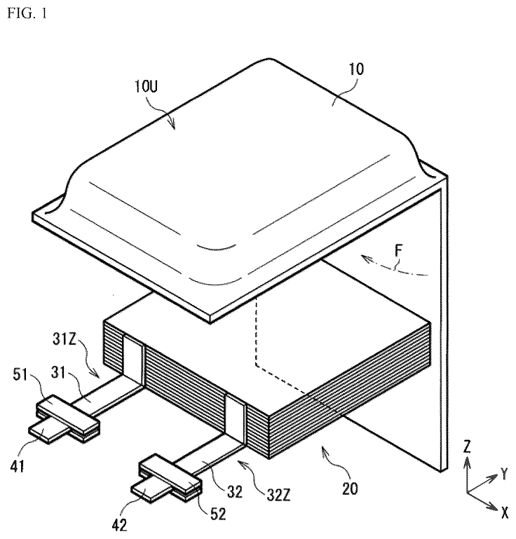

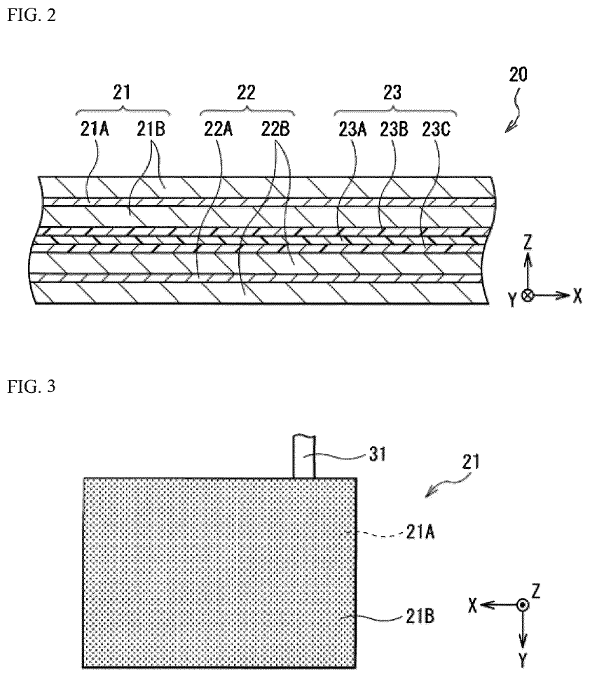

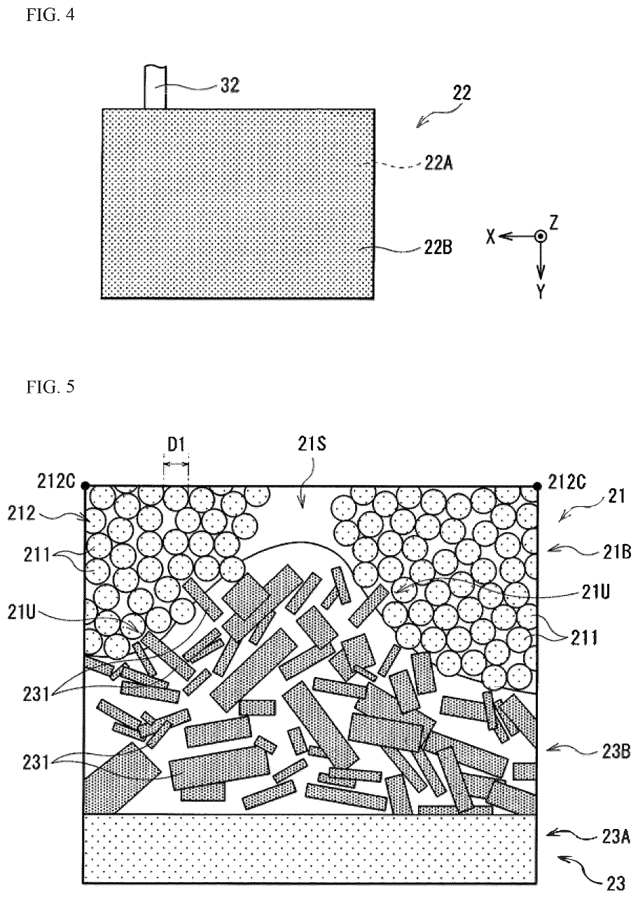

FIG. 1 illustrates a perspective configuration of the secondary battery. FIG. 2 illustrates a sectional configuration of a battery device 20 illustrated in FIG. 1. FIG. 3 illustrates a planar configuration of a positive electrode 21 illustrated in FIG. 2. FIG. 4 illustrates a planar configuration of a negative electrode 22 illustrated in FIG. 2. Note that FIG. 1 illustrates a state where an outer package film 10 and the battery device 20 are separated from each other.

As illustrated in FIGS. 1 and 2, the secondary battery includes the outer package film 10, the battery device 20, multiple positive electrode terminals 31, multiple negative electrode terminals 32, a positive electrode lead 41, a negative electrode lead 42, and sealing films 51 and 52.

The secondary battery to be described here includes the outer package film 10 as an outer package member for containing the battery device 20, the multiple positive electrode terminals 31, and the multiple negative electrode terminals 32, as described above. Accordingly, the secondary battery is what is called a secondary battery of a laminated-film type.

The outer package film 10 is a film-shaped outer package member having flexibility or softness. As illustrated in FIG. 1, the outer package film 10 has a pouch-shaped structure that is sealed in a state where the battery device 20 is contained inside the outer package film 10. The outer package film 10 thus contains the positive electrode 21, the negative electrode 22, a separator 23, and the electrolytic solution that are to be described later.

Here, the outer package film 10 is a single film-shaped member and is folded toward a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state where the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

As illustrated in FIGS. 1 to 4, the battery device 20 is a power generation device that includes the positive electrode 21, the negative electrode 22, the separator 23, and the electrolytic solution (not illustrated). The battery device 20 is contained inside the outer package film 10.

Here, the battery device 20 is what is called a stacked electrode body. In other words, positive electrodes 21 and negative electrodes 22 are alternately stacked on each other with separators 23 each interposed between corresponding one of the positive electrodes 21 and corresponding one of the negative electrodes 22. The respective numbers of the positive electrodes 21, the negative electrodes 22, and the separators 23 are not particularly limited, and may be set as desired.

The positive electrode 21 includes, as illustrated in FIGS. 2 and 3, a positive electrode current collector 21A and a positive electrode active material layer 21B. In FIG. 3, the positive electrode active material layer 21B is shaded.

The positive electrode current collector 21A has two opposed surfaces on each of which the positive electrode active material layer 21B is to be provided. The positive electrode current collector 21A includes an electrically conductive material such as a metal material. Specific examples of the electrically conductive material include aluminum.

The positive electrode active material layer 21B includes any one or more of positive electrode active materials into which lithium is insertable and from which lithium is extractable. Note that the positive electrode active material layer 21B may further include any one or more of other materials including, without limitation, a positive electrode binder and a positive electrode conductor.

Here, the positive electrode active material layer 21B is provided on each of the two opposed surfaces of the positive electrode current collector 21A. Note that the positive electrode active material layer 21B may be provided only on one of the two opposed surfaces of the positive electrode current collector 21A on a side where the positive electrode 21 is opposed to the negative electrode 22. A method of forming the positive electrode active material layer 21B is not particularly limited, and specifically includes a method such as a coating method.

The positive electrode active material is not particularly limited in kind, and specific examples thereof include a lithium-containing compound. The lithium-containing compound is a compound that includes lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table. The lithium-containing compound is not particularly limited in kind, and is specifically, for example, an oxide, a phosphoric acid compound, a silicic acid compound, or a boric acid compound.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15} (Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode active material is in a form of particles. The positive electrode active material layer 21B thus includes primary particles as the positive electrode active material, and secondary particles that are each an aggregate of the primary particles. Note that details of the positive electrode 21 will be described later with reference to FIG. 5.

The positive electrode binder includes any one or more of materials including, without limitation, a synthetic rubber and a polymer compound. Specific examples of the synthetic rubber include a fluorine-based rubber and ethylene propylene diene. Specific examples of the polymer compound include polyvinylidene difluoride, polyimide, and carboxymethyl cellulose.

The positive electrode conductor includes any one or more of electrically conductive materials including, without limitation, a carbon material, a metal material, and an electrically conductive polymer compound. Specific examples of the carbon material include graphite, carbon black, acetylene black, and Ketjen black.

Here, as illustrated in FIG. 3, a portion of the positive electrode current collector 21A protrudes. The positive electrode current collector 21A therefore includes a part protruding toward an outer side relative to the positive electrode active material layer 21B. Hereinafter, the part is referred to as a “protruding part of the positive electrode current collector 21A”. The positive electrode active material layer 21B is not provided on the protruding part of the positive electrode current collector 21A. The protruding part of the positive electrode current collector 21A therefore serves as the positive electrode terminal 31. Note that details of the positive electrode terminal 31 will be described later.

The negative electrode 22 includes, as illustrated in FIGS. 2 and 4, a negative electrode current collector 22A and a negative electrode active material layer 22B. In FIG. 4, the negative electrode active material layer 22B is shaded.

The negative electrode current collector 22A has two opposed surfaces on each of which the negative electrode active material layer 22B is to be provided. The negative electrode current collector 22A includes an electrically conductive material such as a metal material. Specific examples of the electrically conductive material include copper.

The negative electrode active material layer 22B includes any one or more of negative electrode active materials into which lithium is insertable and from which lithium is extractable. Note that the negative electrode active material layer 22B may further include any one or more of other materials including, without limitation, a negative electrode binder and a negative electrode conductor.

Here, the negative electrode active material layer 22B is provided on each of the two opposed surfaces of the negative electrode current collector 22A. Note that the negative electrode active material layer 22B may be provided only on one of the two opposed surfaces of the negative electrode current collector 22A on a side where the negative electrode 22 is opposed to the positive electrode 21. A method of forming the negative electrode active material layer 22B is not particularly limited, and specifically includes any one or more of methods including, without limitation, a coating method, a vapor-phase method, a liquid-phase method, a thermal spraying method, and a firing (sintering) method.

The negative electrode active material is not particularly limited in kind, and specific examples thereof include a carbon material and a metal-based material. A reason for this is that a high energy density is obtainable. Specific examples of the carbon material include graphitizable carbon, non-graphitizable carbon, and graphite (natural graphite and artificial graphite). The metal-based material is a material including, as one or more constituent elements, any one or more elements among metal elements and metalloid elements that are each able to form an alloy with lithium. Specific examples of such metal elements and metalloid elements include silicon and tin. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Details of the negative electrode binder are similar to those of the positive electrode binder, except that the specific examples of the synthetic rubber further include a styrene-butadiene-based rubber. Details of the negative electrode conductor are similar to those of the positive electrode conductor.

Here, as illustrated in FIG. 4, a portion of the negative electrode current collector 22A protrudes. The negative electrode current collector 22A therefore includes a part protruding toward the outer side relative to the negative electrode active material layer 22B. Hereinafter, the part is referred to as a “protruding part of the negative electrode current collector 22A”. The negative electrode active material layer 22B is not provided on the protruding part of the negative electrode current collector 22A. The protruding part of the negative electrode current collector 22A therefore serves as the negative electrode terminal 32. Note that details of the negative electrode terminal 32 will be described later.

As illustrated in FIG. 2, the separator 23 is disposed between the positive electrode 21 and the negative electrode 22, and allows a lithium ion to pass therethrough while preventing contact (a short circuit) between the positive electrode 21 and the negative electrode 22.

In the battery device 20, as described above, the positive electrodes 21 and the negative electrodes 22 are alternately stacked on each other with the separators 23 each interposed between corresponding one of the positive electrodes 21 and corresponding one of the negative electrodes 22. Accordingly, the battery device 20 includes the multiple separators 23.

Here, the separator 23 includes a porous layer 23A, a positive electrode side covering layer 23B, and a negative electrode side covering layer 23C.

The porous layer 23A has multiple fine pores to allow a lithium ion to pass therethrough, and has two opposed surfaces on which the positive electrode side covering layer 23B and the negative electrode side covering layer 23C are to be provided. The porous layer 23A includes an insulating material such as a polymer compound. Specific examples of the insulating material include polyethylene.

The positive electrode side covering layer 23B is disposed between the porous layer 23A and the positive electrode 21 (the positive electrode active material layer 21B), and is adjacent to the positive electrode active material layer 21B. The positive electrode side covering layer 23B includes insulating particles. Note that the positive electrode side covering layer 23B may further include any one or more of other materials including, without limitation, a separator binder.

A reason why the positive electrode side covering layer 23B includes the insulating particles is that the insulating particles promote heat dissipation upon heat generation and heating of the secondary battery. This improves heat resistance of the secondary battery, thus improving safety.

The insulating particles each include any one or more of insulating materials including, without limitation, an inorganic material. Specific examples of the insulating material include a metal hydroxide, a metal oxide, and a metal nitride. A reason for this is that a sufficient heat dissipation property is obtainable. More specifically, examples of the metal hydroxide include magnesium hydroxide and aluminum hydroxide. Examples of the metal oxide include magnesium oxide, aluminum oxide, titanium oxide, silicon oxide, and zirconium oxide. Examples of the metal nitride include aluminum nitride.

The separator binder is a binder that holds the insulating particles, and includes any one or more of polymer compounds. Specifically, the polymer compound includes a homopolymer of vinylidene fluoride, a copolymer of vinylidene fluoride, or both. A reason for this is that this makes it easier for the positive electrode side covering layer 23B to adhere to the positive electrode 21.

The homopolymer of vinylidene fluoride is what is called polyvinylidene difluoride. The copolymer of vinylidene fluoride is a compound in which vinylidene fluoride and another monomer are copolymerized. Specific examples of the other monomer include any one or more of monomers including, without limitation, hexafluoropropylene. A copolymerization amount (wt %) of the other monomer is not particularly limited, and is specifically within a range from 20 wt % to 80 wt % both inclusive.

Note that when the positive electrode side covering layer 23B includes the separator binder together with the insulating particles, a mixture ratio (a weight ratio) between the insulating particles and the separator binder is not particularly limited, and is specifically within a range from 20:80 to 80:20 both inclusive.

The negative electrode side covering layer 23C is disposed between the porous layer 23A and the negative electrode 22 (the negative electrode active material layer 22B), and is adjacent to the negative electrode active material layer 22B. The negative electrode side covering layer 23C includes the separator binder. Details of the separator binder are as described above. Note that the negative electrode side covering layer 23C may include the insulating particles, or may include no insulating particle.

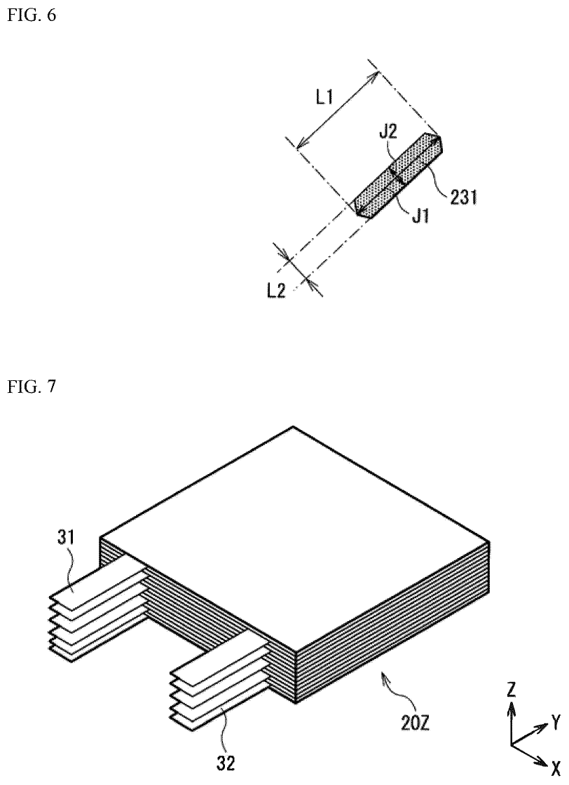

In the secondary battery, a configuration of the positive electrode side covering layer 23B including the insulating particles is made appropriate for improving a battery characteristic. A detailed configuration of the separator 23 will be described later with reference to FIGS. 5 and 6.

The electrolytic solution is a liquid electrolyte. The positive electrode 21, the negative electrode 22, and the separator 23 are each impregnated with the electrolytic solution. The electrolytic solution includes a solvent and an electrolyte salt.

Here, the solvent includes any one or more of non-aqueous solvents (organic solvents), and the electrolytic solution including the non-aqueous solvent(s) is what is called a non-aqueous electrolytic solution. The non-aqueous solvent is, for example, an ester or an ether, more specifically, a carbonic-acid-ester-based compound, a carboxylic-acid-ester-based compound, or a lactone-based compound, for example. A reason for this is that a dissociation property of the electrolyte salt and mobility of ions improve.

The carbonic-acid-ester-based compound is a cyclic carbonic acid ester or a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include ethyl acetate, ethyl propionate, propyl propionate, and ethyl trimethylacetate.

The lactone-based compound is, for example, a lactone. Specific examples of the lactone include γ-butyrolactone and γ-valerolactone.

Note that the ether may be, for example, 1,2-dimethoxyethane, tetrahydrofuran, 1,3-dioxolane, or 1,4-dioxane.

The electrolyte salt includes any one or more of light metal salts including, without limitation, a lithium salt. Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium monofluorophosphate (Li₂PFO₃), and lithium difluorophosphate (LiPF₂O₂). A reason for this is that a high battery capacity is obtainable.

A content of the electrolyte salt is not particularly limited, and is specifically within a range from 0.3 mol/kg to 3.0 mol/kg both inclusive with respect to the solvent. A reason for this is that high ion conductivity is obtainable.

Note that the electrolytic solution may further include any one or more of additives. The additives are not particularly limited in kind, and specific examples thereof include an unsaturated cyclic carbonic acid ester, a fluorinated cyclic carbonic acid ester, a sulfonic acid ester, a phosphoric acid ester, an acid anhydride, a nitrile compound, and an isocyanate compound.

Specific examples of the unsaturated cyclic carbonic acid ester include vinylene carbonate, vinyl ethylene carbonate, and methylene ethylene carbonate. Specific examples of the fluorinated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

The positive electrode terminal 31 is electrically coupled to the positive electrode 21, as illustrated in FIG. 3. More specifically, the positive electrode terminal 31 is electrically coupled to the positive electrode current collector 21A. In the battery device 20, as described above, the positive electrodes 21 and the negative electrodes 22 are alternately stacked on each other with the separators 23 each interposed between corresponding one of the positive electrodes 21 and corresponding one of the negative electrodes 22. Accordingly, the battery device 20 includes the multiple positive electrodes 21. The positive electrode terminal 31 is coupled to each of the multiple positive electrodes 21, and thus, the secondary battery includes the multiple positive electrode terminals 31. A material included in the positive electrode terminal 31 is not particularly limited, and is specifically similar to the material included in the positive electrode current collector 21A.

Here, as described above, the protruding part of the positive electrode current collector 21A serves as the positive electrode terminal 31. Accordingly, the positive electrode terminal 31 is physically integrated with the positive electrode current collector 21A. A reason for this is that coupling resistance between the positive electrode current collector 21A and the positive electrode terminal 31 decreases, and electric resistance of the entire secondary battery therefore decreases.

As will be described later, the multiple positive electrode terminals 31 are joined to each other to thereby form one joint part 31Z having a lead shape, as illustrated in FIG. 1.

The negative electrode terminal 32 is electrically coupled to the negative electrode 22, as illustrated in FIG. 4. More specifically, the negative electrode terminal 32 is electrically coupled to the negative electrode current collector 22A. In the battery device 20, as described above, the positive electrodes 21 and the negative electrodes 22 are alternately stacked on each other with the separators 23 each interposed between corresponding one of the positive electrodes 21 and corresponding one of the negative electrodes 22. Accordingly, the battery device 20 includes the multiple negative electrodes 22. The negative electrode terminal 32 is coupled to each of the multiple negative electrodes 22, and thus, the secondary battery includes the multiple negative electrode terminals 32. A material included in the negative electrode terminal 32 is not particularly limited, and is specifically similar to the material included in the negative electrode current collector 22A.

Note that, in a state where the positive electrodes 21 and the negative electrodes 22 are alternately stacked on each other with the separators 23 each interposed between corresponding one of the positive electrodes 21 and corresponding one of the negative electrodes 22, the negative electrode terminals 32 are each disposed at a position not overlapping the positive electrode terminals 31.

Here, as described above, the protruding part of the negative electrode current collector 22A serves as the negative electrode terminal 32. Accordingly, the negative electrode terminal 32 is physically integrated with the negative electrode current collector 22A. A reason for this is that coupling resistance between the negative electrode current collector 22A and the negative electrode terminal 32 decreases, and the electric resistance of the entire secondary battery therefore decreases.

As will be described later, the multiple negative electrode terminals 32 are joined to each other to thereby form one joint part 32Z having a lead shape, as illustrated in FIG. 1.

### [Positive Electrode Lead and Negative Electrode Lead]

As illustrated in FIG. 1, the positive electrode lead 41 is coupled to the joint part 31Z including the multiple positive electrode terminals 31 that are joined to each other, and is led from the outer package film 10. A material included in the positive electrode lead 41 is not particularly limited, and is specifically similar to the material included in the positive electrode current collector 21A. The positive electrode lead 41 is not particularly limited in shape, and specifically has any of shapes including, without limitation, a thin plate shape and a meshed shape.

As illustrated in FIG. 1, the negative electrode lead 42 is coupled to the joint part 32Z including the multiple negative electrode terminals 32 that are joined to each other, and is led from the outer package film 10. A material included in the negative electrode lead 42 is not particularly limited, and is specifically similar to the material included in the negative electrode current collector 22A. Note that the negative electrode lead 42 is led in a direction similar to that in which the positive electrode lead 41 is led. Details of a shape of the negative electrode lead 42 are similar to those of the shape of the positive electrode lead 41.

The sealing films 51 and 52 are each a sealing member that prevents entry of, for example, outside air into the outer package film 10. The sealing film 51 is interposed between the outer package film 10 and the positive electrode lead 41. The sealing film 52 is interposed between the outer package film 10 and the negative electrode lead 42. Note that the sealing film 51, the sealing film 52, or both may be omitted.

The sealing film 51 includes a polymer compound such as a polyolefin that has adherence to the positive electrode lead 41. Specific examples of the polymer compound include polypropylene.

A configuration of the sealing film 52 is similar to that of the sealing film 51 except that the sealing film 52 has adherence to the negative electrode lead 42. That is, the sealing film 52 includes a polymer compound such as a polyolefin that has adherence to the negative electrode lead 42.

FIG. 5 schematically illustrates in an enlarged manner a configuration of the battery device 20 after a heating test to be described later. FIG. 5 corresponds to FIG. 2. FIG. 6 schematically illustrates a configuration of an insulating particle 231. FIG. 6 corresponds to FIG. 5.

Note that, as is apparent from FIG. 2, FIG. 5 illustrates a sectional configuration of the battery device 20 in the vicinity of an interface between the positive electrode 21 and the separator 23. Further, for simple illustration, FIG. 5 illustrates a case where primary particles 211 each have a circular shape and insulating particles 231 each have a rectangular shape.

FIG. 6 illustrates only one insulating particle 231 extracted from the insulating particles 231 illustrated in FIG. 5. Further, for describing the configuration of the insulating particle 231 in detail, FIG. 6 illustrates a case where the insulating particle 231 has a hexagonal shape.

In a direction (a Z-axis direction) in which the positive electrodes 21 and the negative electrodes 22 are alternately stacked on each other with the separators 23 each interposed between corresponding one of the positive electrodes 21 and corresponding one of the negative electrodes 22, the battery device 20 is cut by a cutting tool to thereby expose a section of the battery device 20. Thereafter, when the section (the section along an XZ plane) of the battery device 20 is observed with use of an electron microscope, an observation result (a sectional configuration) illustrated in FIG. 5 is obtained.

Usable as the cutting tool is, for example, a cross section polisher (registered trademark) available from JEOL Ltd.

Usable as the electron microscope are any one or more of electron microscopes including, without limitation, a scanning electron microscope (SEM) and a transmission electron microscope. FIG. 5 schematically illustrates what is called an electron microscope photograph. An observation magnification is not particularly limited, and is specifically set to 20000 times.

As illustrated in FIG. 5, the positive electrode 21 and the separator 23 are adjacent to each other. The separator 23 includes the porous layer 23A and the positive electrode side covering layer 23B. The positive electrode side covering layer 23B is thus interposed between the porous layer 23A and the positive electrode active material layer 21B. The positive electrode side covering layer 23B is therefore adjacent to the positive electrode active material layer 21B.

As described above, the positive electrode active material layer 21B includes the primary particles 211 as the positive electrode active material, and secondary particles 212 that are each an aggregate (a gathering) of the primary particles 211. In FIG. 5, each of the primary particles 211 is lightly shaded, and only respective portions of two secondary particles 212 adjacent to each other are illustrated.

Each of the two secondary particles 212 has a substantially circular shape. The two secondary particles 212 have a gap 21S therebetween. This gap 21S is a space sandwiched by the two secondary particles 212 that are adjacent to each other. Although the two secondary particles 212 are separated from each other here, the two secondary particles 212 may be adjacent to each other.

The positive electrode side covering layer 23B includes the insulating particles 231. Each of the insulating particles 231 has an elongated shape extending in any direction. That is, each of the insulating particles 231 has a major axis J1 and a minor axis J2 (see FIG. 6), which will be described later, and thus has a shape defined by the major axis J1 and the minor axis J2. Respective definitions of the major axis J1 and the minor axis J2 will be described later.

However, the positive electrode side covering layer 23B may further include other insulating particles (not illustrated). Each of the other insulating particles has neither the major axis J1 nor the minor axis J2, and thus does not have the shape defined by the major axis J1 and the minor axis J2.

The “shape” described herein is a planar shape of each of the insulating particles 231 identified based on the electron microscope photograph, as is apparent from FIG. 5, that is, a shape defined by an outer edge of each of the insulating particles 231. In FIG. 5, the porous layer 23A is lightly shaded, and each of the insulating particles 231 is darkly shaded.

Here, with regard to a configuration of the primary particles 211 and a configuration of the insulating particles 231, predetermined conditions are satisfied in order to improve the battery characteristic.

Specifically, attention is paid to an average particle size D of the primary particles 211 and an average length L of the respective minor axes J2 of the insulating particles 231. In this case, the average particle size D is within a range from 100 nm to 2120 nm both inclusive, and a dimensional ratio T that is a ratio of the average length L to the average particle size D is within a range from 0.22 to 1.00 both inclusive. The dimensional ratio T is calculated based on the following calculation expression: dimensional ratio T=average length L/average particle size D. Note that a value of the dimensional ratio T is a value rounded off to two decimal places. Respective calculation procedures of the average particle size D and the average length L will be described later.

A reason why the average particle size D is within the range from 100 nm to 2120 nm both inclusive and the dimensional ratio T is within the range from 0.22 to 1.00 both inclusive is that a value of the average particle size D and a value of the average length L become appropriately close to each other, which suppresses a reduction in discharge capacity even upon repeated charging and discharging, and also suppresses occurrence of a short circuit.

In detail, when the secondary battery is heated at a high temperature during, for example, heat generation of the secondary battery, the porous layer 23A of the separator 23 undergoes thermal contraction. In this case, if the appropriate condition related to the dimensional ratio T (i.e., the dimensional ratio T being within the range from 0.22 to 1.00 both inclusive) is not satisfied, the positive electrode side covering layer 23B is pulled in response to the thermal contraction of the porous layer 23A, which causes the positive electrode side covering layer 23B to be easily peeled off from the positive electrode active material layer 21B. This makes it difficult for the positive electrode side covering layer 23B having an insulating property to be interposed between the positive electrode 21 and the negative electrode 22, which causes a short circuit to occur easily.

In contrast, if the appropriate condition related to the dimensional ratio T is satisfied when the secondary battery is heated at a high temperature, the positive electrode side covering layer 23B including the insulating particles 231 flows, which causes, as illustrated in FIG. 5, the insulating particle 231 to partially enter a depression 21U provided in the positive electrode active material layer 21B. The depression 21U is a space surrounded by two or more of the primary particles 211 that are adjacent to each other, and opens toward the separator 23 (the positive electrode side covering layer 23B). Note that the two or more of the primary particles 211 that are adjacent to each other to form the depression 21U may be separated from each other or may be adjacent to each other. It goes without saying that only one or more, but not all, of the primary particles 211 out of the two or more of the primary particles 211 may be adjacent to each other.

In this case, multiple depressions 21U may be provided in the positive electrode active material layer 21B, and the insulating particle 231 may partially enter each of the multiple depressions 21U. That is, the number of locations where the insulating particle 231 partially enters the depression 21U is not limited to only one, and may be two or more. It goes without saying that the insulating particle 231 may partially enter each of only one or more, but not all, of the multiple depressions 21U, and thus, the insulating particle 231 may not partially enter each of the remaining depression(s) 21U.

Further, only one insulating particle 231 may partially enter one depression 21U, or two or more insulating particles 231 may each partially enter one depression 21U.

The phrase “the insulating particle 231 partially enters the depression 21U” means that only a portion (what is called an end part) of the insulating particle 231, rather than the entire insulating particle 231, is received in the depression 21U.

When the insulating particle 231 partially enters the depression 21U, the insulating particle 231 serves as a pile that partially penetrates the positive electrode active material layer 21B (the secondary particle 212). This increases a frictional force of the positive electrode side covering layer 23B on the positive electrode 21 as compared with when the appropriate condition related to the dimensional ratio T is not satisfied, i.e., when the insulating particle 231 does not partially enter the depression 21U. Accordingly, an adhesion force of the separator 23 on the positive electrode 21 increases.

In this case, even if the porous layer 23A undergoes thermal contraction, the positive electrode side covering layer 23B is easily caught by the insulating particle 231 on a surface of the positive electrode active material layer 21B. This prevents the positive electrode side covering layer 23B from being easily peeled off from the positive electrode active material layer 21B. As a result, it becomes easier to maintain an adhesion state of the positive electrode side covering layer 23B to the positive electrode active material layer 21B, which makes it easier for the positive electrode side covering layer 23B having the insulating property to be interposed between the positive electrode 21 and the negative electrode 22. Accordingly, occurrence of a short circuit between the positive electrode 21 and the negative electrode 22 is suppressed.

In addition, if the appropriate condition related to the average particle size D (i.e., the average particle size D being within the range from 100 nm to 2120 nm both inclusive) is satisfied, the average particle size D is made appropriate, which prevents insertion and extraction of lithium into and from the primary particle 211 from being hindered easily. Accordingly, even if the secondary battery is repeatedly charged and discharged, a reduction in discharge capacity is suppressed.

Based upon the foregoing, if the appropriate condition related to the average particle size D and the appropriate condition related to the dimensional ratio T are satisfied, it becomes easier for the positive electrode side covering layer 23B having the insulating property to be interposed between the positive electrode 21 and the negative electrode 22 upon heating of the secondary battery, and insertion and extraction of lithium into and from the primary particle 211 is prevented from being hindered easily. Accordingly, as described above, a reduction in discharge capacity is suppressed even upon repeated charging and discharging, and the occurrence of a short circuit is also suppressed.

In order to obtain the advantages described above, it is preferable that the insulating particle 231 partially enter the depression 21U after the heating test is performed with the secondary battery, as described above.

Specifically, it is preferable that, after the charged secondary battery that has been charged under the following charging condition is heated under a condition of 130° C. and 60 minutes, the insulating particle 231 partially enter the depression 21U as illustrated in FIG. 5.

The charging condition is as follows. In an environment of 25° C., the secondary battery is charged with a constant current of 0.2 C until a voltage reaches 4.25 V, and is thereafter charged with a constant voltage of 4.25 V until a total charging time reaches 6 hours. Note that 0.2 C is a value of a current that causes a battery capacity (a theoretical capacity) to be completely discharged in 5 hours.

Note that, as illustrated in FIG. 5, it is preferable that the positive electrode side covering layer 23B partially enter the gap 21S provided in the positive electrode active material layer 21B. In this case, it is preferable that a thickness (a dimension in a vertical direction in FIG. 5) of the positive electrode side covering layer 23B in a region in which a portion of the positive electrode side covering layer 23B enters the gap 21S be larger than a thickness of the positive electrode side covering layer 23B in a region other than the region in which the portion of the positive electrode side covering layer 23B enters the gap 21S. A reason for this is that this further increases the frictional force of the positive electrode side covering layer 23B on the positive electrode 21. As a result, the adhesion force of the separator 23 on the positive electrode 21 further increases, which further suppresses the occurrence of a short circuit.

Note that the “thickness of the positive electrode side covering layer 23B in a region in which a portion of the positive electrode side covering layer 23B enters the gap 21S” is a maximum thickness of the positive electrode side covering layer 23B in a region between a center 212C of one of the secondary particles 212 on one side (the left side in FIG. 5) and a center 212C of another one of the secondary particles 212 on another side (the right side in FIG. 5). The “thickness of the positive electrode side covering layer 23B in a region other than the region in which the portion of the positive electrode side covering layer 23B enters the gap 21S” is a thickness of the positive electrode side covering layer 23B at a position of the center 212C of the one secondary particle 212 and is also a thickness of the positive electrode side covering layer 23B at a position of the center 212C of the other secondary particle 212.

A perfect circle having an area equivalent to an area of the secondary particle 212 having a substantially circular shape may be identified. In such a case, the center 212C is the center of such a perfect circle. When identifying the perfect circle, image processing may be used to change the substantially circular shape into the perfect circle, on an as-needed basis.

The major axis J1 is an axis represented by a straight line representing a maximum outer diameter of the insulating particle 231 and has a length L1 (nm). The minor axis J2 is an axis orthogonal to the major axis J1 and bisecting the major axis J1 (the length L1), and has a length L2 (nm). That is, an angle determined by the major axis J1 and the minor axis J2 is 90°.

An average aspect ratio R of the insulating particles 231 each defined by the major axis J1 and the minor axis J2 is not particularly limited. Details of a calculation procedure of the average aspect ratio R will be described later.

In particular, the average aspect ratio R is preferably within a range from 1.5 to 3.0 both inclusive. A reason for this is that if the average aspect ratio R is greater than or equal to 1.5, it becomes easier for the insulating particle 231 to partially enter the depression 21U, which sufficiently increases the adhesion force (the frictional force) of the separator 23 on the positive electrode 21. Another reason for this is that if the average aspect ratio R is less than or equal to 3.0, damage to the porous layer 23A caused by the insulating particle 231 is prevented from occurring easily, which sufficiently suppresses the occurrence of a short circuit. Note that a value of the average aspect ratio R is a value rounded off to one decimal place.

Note that the respective shapes of the insulating particles 231 are not particularly limited as long as the above-described condition related to the average aspect ratio R of the insulating particles 231 is satisfied. In particular, the insulating particles 231 each preferably have a flaky shape. A reason for this is that the shape of the insulating particle 231 having the major axis J1 and the minor axis J2 is easily secured, which makes it easier for the insulating particle 231 to partially enter the depression 21U.

Respective calculation procedures of the dimensional ratio T and the average aspect ratio R, and a checking procedure regarding a state of the insulating particle 231 are as described below. The calculation procedures and the checking procedure described here are performed based on the electron microscope photograph (FIGS. 5 and 6).

First, as illustrated in FIG. 5, the average particle size D of the primary particles 211 is calculated. In this case, any ten primary particles 211 are selected from the primary particles 211 to thereby measure a particle size D1 (nm) of each of the ten primary particles 211. The particle size D1 is a minimum value of an outer diameter of the primary particle 211. Thereafter, an average value of the ten particle sizes D1 is calculated to thereby obtain the average particle size D. Note that the average particle size D is a value rounded off to the nearest whole number.

Thereafter, as illustrated in FIGS. 5 and 6, the average length L of the respective minor axes J2 of the insulating particles 231 is calculated. In this case, any ten insulating particles 231 are selected from the insulating particles 231 to thereby measure the length L2 (nm) of the minor axis J2 of each of the ten insulating particles 231. Thereafter, an average value of the ten lengths L2 is calculated to thereby obtain the average length L. Note that the average length L is a value rounded off to the nearest whole number.

Lastly, the dimensional ratio T is calculated based on the average particle size D and the average length L.

The dimensional ratio T is a parameter indicating how close the value of the average particle size D and the value of the average length L are to each other, as described above. When the dimensional ratio T is less than or equal to 1, the average length L is less than or equal to the average particle size D, which makes it easier for the insulating particle 231 to partially enter the depression 21U. In contrast, when the dimensional ratio T is greater than 1, the average length L is larger than the average particle size D, which makes it difficult for the insulating particle 231 to partially enter the depression 21U.

First, as illustrated in FIG. 5, the insulating particles 231 are identified based on the electron microscope photograph. In this case, only the insulating particles 231 that are entirely included in a range of the electron microscope photograph are to be identified, and the insulating particles 231 that are not entirely included in the range are excluded from those that are to be identified.

Thereafter, as illustrated in FIG. 6, each of the major axis J1 and the minor axis J2 of the insulating particle 231 is identified, following which the length L1 (nm) of the major axis J1 is measured and the length L2 (nm) of the minor axis J2 is measured. The aspect ratio (=length L1/length L2) is calculated based on the length L1 and the length L2.

Lastly, any ten insulating particles 231 are selected from the insulating particles 231 to thereby calculate the aspect ratio of each of the ten insulating particles 231. Thereafter, an average value of the ten aspect ratios is calculated to thereby obtain the average aspect ratio R.

First, the secondary battery is charged under the above-described charging condition. Thereafter, the charged secondary battery is heated under a condition of 130° C. and 60 minutes. In this case, the secondary battery is stored (for a storage time of 60 minutes) inside a heater such as an oven (at a temperature of 130° C.).

Note that the heating temperature is not limited to 130° C., and may be 130° C.±2° C. The heating time is not limited to 60 minutes, and may be 60 minutes±10 minutes.

Thereafter, as illustrated in FIG. 5, the insulating particles 231 existing inside the positive electrode side covering layer 23B are visually identified based on the electron microscope photograph. If the positive electrode side covering layer 23B includes the insulating particles having various shapes, the insulating particles having neither the major axis J1 nor the minor axis J2 are excluded and only the insulating particles having the major axis J1 and the minor axis J2 are extracted. The insulating particles each having the major axis J1 and the minor axis J2 are regarded as the insulating particles 231.

Thereafter, the secondary particles 212 (the primary particles 211) existing inside the positive electrode active material layer 21B are visually checked based on the electron microscope photograph to thereby identify the depression 21U. In this case, regarded as the depression 21U on a surface of the positive electrode active material layer 21B (an interface between the positive electrode active material layer 21B and the positive electrode side covering layer 23B) is a space surrounded by two or more of the primary particles 211 that are adjacent to each other, that is, a location at which a surface of the secondary particle 212 is partially recessed.

Lastly, visual checking is performed on whether the insulating particle 231 that partially enters the depression 21U exists among the insulating particles 231. As illustrated in FIG. 5, when the insulating particle 231 that partially enters the depression 21U exists, the insulating particle 231 partially digs into the secondary particle 212. This makes it possible to identify the insulating particle 231 easily and with high reproducibility.

Upon charging the secondary battery, in the battery device 20, lithium is extracted from the positive electrode 21, and the extracted lithium is inserted into the negative electrode 22 via the electrolytic solution. Upon discharging the secondary battery, in the battery device 20, lithium is extracted from the negative electrode 22, and the extracted lithium is inserted into the positive electrode 21 via the electrolytic solution. Upon the charging and discharging, lithium is inserted and extracted in an ionic state.

FIG. 7 illustrates a perspective configuration corresponding to FIG. 1 for describing a method of manufacturing the secondary battery. Note that FIG. 7 illustrates, in place of the battery device 20, a stacked body 20Z to be used to fabricate the battery device 20. Details of the stacked body 20Z will be described later.

In a case of manufacturing the secondary battery, the positive electrode 21, the negative electrode 22, and the separator 23 are each fabricated, and the electrolytic solution is prepared, following which the secondary battery is assembled using the positive electrode 21, the negative electrode 22, the separator 23, and the electrolytic solution, and a stabilization process of the secondary battery is performed, according to an example procedure to be described below.

First, a mixture (a positive electrode mixture) in which the positive electrode active material, the positive electrode binder, and the positive electrode conductor are mixed with each other is put into a solvent to thereby prepare a positive electrode mixture slurry in paste form. The solvent may be an aqueous solvent, or may be an organic solvent. Thereafter, the positive electrode mixture slurry is applied on the two opposed surfaces (excluding the positive electrode terminal 31) of the positive electrode current collector 21A integrated with the positive electrode terminal 31 to thereby form the positive electrode active material layers 21B. Lastly, the positive electrode active material layers 21B are compression-molded by means of, for example, a roll pressing machine. In this case, the positive electrode active material layers 21B may be heated. The positive electrode active material layers 21B may be compression-molded multiple times. The positive electrode active material layers 21B are thus formed on the two respective opposed surfaces of the positive electrode current collector 21A. As a result, the positive electrode 21 is fabricated.

The negative electrode 22 is formed by a procedure similar to the fabrication procedure of the positive electrode 21 described above. Specifically, first, a mixture (a negative electrode mixture) in which the negative electrode active material, the negative electrode binder, and the negative electrode conductor are mixed with each other is put into a solvent to thereby prepare a negative electrode mixture slurry in paste form. Thereafter, the negative electrode mixture slurry is applied on the two opposed surfaces (excluding the negative electrode terminal 32) of the negative electrode current collector 22A integrated with the negative electrode terminal 32 to thereby form the negative electrode active material layers 22B. Lastly, the negative electrode active material layers 22B are compression-molded. The negative electrode active material layers 22B are thus formed on the two respective opposed surfaces of the negative electrode current collector 22A. As a result, the negative electrode 22 is fabricated.

First, a mixture in which the insulating particles 231 and the separator binder are mixed with each other is put into a solvent to thereby prepare a slurry in paste form. Details of the solvent are as described above.

Thereafter, the slurry is applied on one of the two opposed surfaces of the porous layer 23A to thereby form the positive electrode side covering layer 23B including the insulating particles 231.

Thereafter, the separator binder is put into a solvent to thereby prepare a slurry in paste form. Thereafter, the slurry is applied on one of the two opposed surfaces, of the porous layer 23A, on which the positive electrode side covering layer 23B is not formed to thereby form the negative electrode side covering layer 23C including no insulating particle 231.

Thus, the positive electrode side covering layer 23B is formed on one of the two opposed surfaces of the porous layer 23A, and the negative electrode side covering layer 23C is formed on an opposite one of the two opposed surfaces of the porous layer 23A. As a result, the separator 23 is assembled.

Lastly, in a process of assembling the secondary battery to be described later, the outer package film 10 in which the stacked body 20Z is contained is hot-pressed. In the hot press process, the stacked body 20Z is pressed while being heated through the outer package film 10. Thus, the porous layer 23A adheres to the positive electrode 21 with the positive electrode side covering layer 23B interposed therebetween, and the porous layer 23A adheres to the negative electrode 22 with the negative electrode side covering layer 23C interposed therebetween. As a result, the separator 23 is fabricated.

In this case, the positive electrode side covering layer 23B is pushed toward the positive electrode active material layer 21B (the secondary particles 212) by changing pressing conditions including, for example, a pressing force, a pressing time, and a heating temperature. Accordingly, it is possible to so control the state of the insulating particle 231 as to make it easier for the insulating particle 231 to partially enter the depression 21U upon heating of the secondary battery, in accordance with the above-described pressing conditions.

The electrolyte salt is put into the solvent. The electrolyte salt is thereby dispersed or dissolved in the solvent. As a result, the electrolytic solution is prepared.

First, the positive electrodes 21 and the negative electrodes 22 are alternately stacked on each other with the separators 23 each interposed between corresponding one of the positive electrodes 21 and corresponding one of the negative electrodes 22 to thereby form the stacked body 20Z, as illustrated in FIG. 7. The stacked body 20Z has a configuration similar to the configuration of the battery device 20 except that the positive electrodes 21, the negative electrodes 22, and the separators 23 are each not impregnated with the electrolytic solution.

Thereafter, the multiple positive electrode terminals 31 are joined to each other by a joining method such as a welding method to thereby form the joint part 31Z, following which the positive electrode lead 41 is coupled to the joint part 31Z. Further, the multiple negative electrode terminals 32 are joined to each other by a joining method such as a welding method to thereby form the joint part 32Z, following which the negative electrode lead 42 is coupled to the joint part 32Z.

Thereafter, the stacked body 20Z is placed in the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the fusion-bonding layer opposed to each other are bonded to each other by a bonding method such as a thermal-fusion-bonding method to thereby allow the stacked body 20Z to be contained in the outer package film 10 having a pouch shape. In this case, the positive electrode lead 41 and the negative electrode lead 42 are each led from the outer package film 10.

Thereafter, the electrolytic solution is injected into the outer package film 10 having the pouch shape, following which outer edge parts of the remaining one side of the fusion-bonding layer opposed to each other are bonded to each other by a bonding method such as a thermal-fusion-bonding method. In this case, the sealing film 51 is interposed between the outer package film 10 and the positive electrode lead 41, and the sealing film 52 is interposed between the outer package film 10 and the negative electrode lead 42.

Lastly, the outer package film 10 in which the stacked body 20Z is contained is hot-pressed by means of an unillustrated pressing machine including a pair of pressing plates. In this case, the outer package film 10 is disposed between the pair of pressing plates. Thereafter, while being heated, the outer package film 10 is pressed from above and below in the direction (the Z-axis direction) in which the positive electrodes 21 and the negative electrodes 22 are alternately stacked on each other with the separators 23 each interposed between corresponding one of the positive electrodes 21 and corresponding one of the negative electrodes 22.

The stacked body 20Z is thereby impregnated with the electrolytic solution. Further, as described above, the insulating particle 231 partially enters the depression 21U. As a result, the separator 23 is fabricated. Thus, the battery device 20, i.e., the stacked electrode body, is fabricated, and the battery device 20 is sealed in the outer package film 10 having the pouch shape. As a result, the secondary battery is assembled.

The assembled secondary battery is charged and discharged. Conditions including, for example, an environment temperature, the number of times of charging and discharging (the number of cycles), and charging and discharging conditions may be set as desired. As a result, a film is formed on a surface of each of the positive electrode 21 and the negative electrode 22, which electrochemically stabilizes a state of the secondary battery. As a result, the secondary battery is completed.

According to the secondary battery, the separator 23 including the porous layer 23A and the positive electrode side covering layer 23B is disposed between the positive electrode 21 and the negative electrode 22. Further, the positive electrode 21 includes the primary particles 211 as the positive electrode active material. The positive electrode side covering layer 23B disposed between the porous layer 23A and the positive electrode 21 includes the insulating particles 231. The insulating particles 231 each have the major axis J1 and the minor axis J2. In addition, the average particle size D is within the range from 100 nm to 2120 nm both inclusive, and the dimensional ratio T is within the range from 0.22 to 1.00 both inclusive.

In this case, as described above, the value of the average particle size D and the value of the average length L are close to each other. Accordingly, when the positive electrode side covering layer 23B flows upon heating of the secondary battery, it becomes easier for the insulating particle 231 to partially enter the depression 21U. As a result, the frictional force (the adhesion force) of the positive electrode side covering layer 23B on the positive electrode 21 increases. This makes it easier for the positive electrode side covering layer 23B having the insulating property to be interposed between the positive electrode 21 and the negative electrode 22, without being peeled off from the positive electrode 21 even if the porous layer 23A undergoes thermal contraction. Accordingly, the occurrence of a short circuit is suppressed.

In addition, as described above, the average particle size D is made appropriate, which prevents insertion and extraction of lithium into and from the primary particle 211 from being hindered easily. Accordingly, even if the secondary battery is repeatedly charged and discharged, a reduction in discharge capacity is suppressed.

Based upon the foregoing, a reduction in discharge capacity is suppressed even upon repeated charging and discharging, and the occurrence of a short circuit is also suppressed. It is therefore possible to achieve a superior battery characteristic.

In particular, the insulating particle 231 may partially enter the depression 21U. This suppresses, as described above, the occurrence of a short circuit with use of the insulating particles 231 even if the porous layer 23A undergoes thermal contraction. It is therefore possible to achieve higher effects.

Further, the average aspect ratio R of the insulating particles 231 may be within the range from 1.5 to 3.0 both inclusive. This makes it easier for the insulating particle 231 to partially enter the depression 21U upon heating of the secondary battery, and prevents damage to the porous layer 23A caused by the insulating particle from occurring easily. It is therefore possible to achieve higher effects.

Further, the insulating particles 231 may each have a flaky shape. This makes it easier to secure the shape of the insulating particle 231 having the major axis J1 and the minor axis J2. It is therefore possible to achieve higher effects.

Further, the positive electrode 21 may include the secondary particles 212, and the positive electrode side covering layer 23B may partially enter the gap 21S. This further increases the frictional force of the positive electrode side covering layer 23B on the positive electrode 21. Accordingly, the adhesion force of the separator 23 on the positive electrode 21 further increases. It is therefore possible to achieve higher effects.

In this case, the thickness of the positive electrode side covering layer 23B in the region in which a portion of the positive electrode side covering layer 23B enters the gap 21S may be larger than the thickness of the positive electrode side covering layer 23B in the region other than the region in which the portion of the positive electrode side covering layer 23B enters the gap 21S. This sufficiently increases the frictional force of the positive electrode side covering layer 23B on the positive electrode 21. It is therefore possible to achieve further higher effects.

Further, the positive electrode side covering layer 23B may further include the separator binder. With use of such a separator binder, it becomes easier to maintain the state of the insulating particle 231, that is, the state of the insulating particle 231 partially entering the depression 21U. Accordingly, it becomes easier to maintain the adhesion force of the separator 23 on the positive electrode 21. It is therefore possible to achieve higher effects.

Further, the insulating particles 231 may each include any one or more of the metal hydroxide, the metal oxide, or the metal nitride. This makes it possible to obtain a sufficient heat dissipation property. It is therefore possible to achieve higher effects.

Further, the positive electrode 21 and the negative electrode 22 may be alternately stacked on each other with the separator 23 interposed therebetween. This effectively suppresses the occurrence of a short circuit in response to an increase in the adhesion force of the separator 23 on the positive electrode 21. It is therefore possible to achieve higher effects.

In this case, the positive electrode terminals 31 may be coupled to the respective multiple positive electrodes 21, the negative electrode terminals 32 may be coupled to the respective multiple negative electrodes 22, the multiple positive electrode terminals 31 may be joined to each other, and the multiple negative electrode terminals 32 may be joined to each other. This effectively suppresses the occurrence of a short circuit while securing the battery capacity. It is therefore possible to achieve further higher effects.

In addition, the outer package film 10 may contain the battery device 20 inside the outer package film 10, the positive electrode lead 41 joined to the joint part 31Z may be led from the outer package film 10, and the negative electrode lead 42 joined to the joint part 32Z may be led from the outer package film 10. This improves a sealing property of the outer package film 10 even if the multiple positive electrode terminals 31 and the multiple negative electrode terminals 32 are used. It is therefore possible to achieve markedly higher effects.

In detail, when the joint part 31Z is led from the outer package film 10, the joint part 31Z that is a joined body of the multiple positive electrode terminals 31 has a large thickness, which causes a gap to be generated easily between the outer package film 10 and the joint part 31Z. As a result, it becomes difficult to seal the outer package film 10 using the sealing film 51, and thus the sealing property of the outer package film 10 decreases.

In contrast, when the positive electrode lead 41 is led from the outer package film 10, the positive electrode lead 41 has a thickness smaller than the thickness of the joint part 31Z that is the joined body of the multiple positive electrode terminals 31, which prevents a gap from being generated easily between the outer package film 10 and the positive electrode lead 41. This makes it easier to seal the outer package film 10 using the sealing film 51, and thus the sealing property of the outer package film 10 improves.

Note that the above-described advantage obtained when the positive electrode lead 41 is led from the outer package film 10 is also similarly achievable when the negative electrode lead 42 is led from the outer package film 10. In other words, leading the negative electrode lead 42 instead of the joint part 32Z from the outer package film 10 makes it easier to seal the outer package film 10 using the sealing film 52, and thus the sealing property of the outer package film 10 improves.

Further, the secondary battery may include a lithium-ion secondary battery. This makes it possible to obtain a sufficient battery capacity stably through insertion and extraction of lithium. Accordingly, it is possible to achieve higher effects.

The configuration of the secondary battery described above is appropriately modifiable including as described below according to an embodiment.

In FIG. 2, the separator 23 includes both the positive electrode side covering layer 23B and the negative electrode side covering layer 23C. However, the separator 23 may include no negative electrode side covering layer 23C and may include only the positive electrode side covering layer 23B. In this case also, the adhesion force of the separator 23 on the positive electrode 21 increases with use of the positive electrode side covering layer 23B, and similar effects are therefore obtainable.

In FIG. 3, the protruding part of the positive electrode current collector 21A also serves as the positive electrode terminal 31. Accordingly, the positive electrode terminal 31 is physically integrated with the positive electrode current collector 21A. However, the positive electrode terminal 31 may be physically separated from the positive electrode current collector 21A, and the positive electrode terminal 31 may thus be provided separately from the positive electrode current collector 21A. In this case, the positive electrode terminal 31 may be coupled to the positive electrode current collector 21A by a joining method such as a welding method.

In this case also, the positive electrode terminal 31 is electrically coupled to the positive electrode 21, and similar effects are therefore obtainable. Note that, to reduce the coupling resistance and accordingly reduce the electric resistance of the entire secondary battery, the positive electrode terminal 31 is preferably physically integrated with the positive electrode current collector 21A.

Likewise, in FIG. 4, the protruding part of the negative electrode current collector 22A also serves as the negative electrode terminal 32. Accordingly, the negative electrode terminal 32 is physically integrated with the negative electrode current collector 22A. However, the negative electrode terminal 32 may be physically separated from the negative electrode current collector 22A, and the negative electrode terminal 32 may thus be provided separately from the negative electrode current collector 22A. In this case, the negative electrode terminal 32 may be coupled to the negative electrode current collector 22A by a joining method such as a welding method.

In this case also, the negative electrode terminal 32 is electrically coupled to the negative electrode 22, and similar effects are therefore obtainable. Note that, to reduce the coupling resistance and accordingly reduce the electric resistance of the entire secondary battery, the negative electrode terminal 32 is preferably physically integrated with the negative electrode current collector 22A.

In FIG. 2, the battery device 20 that is a stacked electrode body is used. However, although not specifically illustrated here, the battery device 20 that is a wound electrode body may be used. In this case, the positive electrode 21 has a band-shaped structure, and the positive electrode lead 41 is coupled to the positive electrode current collector 21A. The negative electrode 22 has a band-shaped structure, and the negative electrode lead 42 is coupled to the negative electrode current collector 22A. Note that the number of the positive electrode leads 41 may be one, or two or more, and the number of the negative electrode leads 42 may be one, or two or more. The positive electrode 21 and the negative electrode 22 are thus wound, being opposed to each other with the separator 23 interposed therebetween.

In this case also, the secondary battery is chargeable and dischargeable with use of the battery device 20, and similar effects are therefore obtainable.

Applications (application examples) of the secondary battery are not particularly limited. The secondary battery used as a power source may serve as a main power source or an auxiliary power source in applications including, without limitation, electronic equipment and an electric vehicle. The main power source is preferentially used regardless of the presence of any other power source. The auxiliary power source may be used in place of the main power source, or may be switched from the main power source.

Specific examples of the applications of the secondary battery are as described below. The specific examples include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery packs may each include a single battery, or may each include an assembled battery. The electric vehicle is a vehicle that travels with the secondary battery as a driving power source, and may be a hybrid automobile that is additionally provided with a driving source other than the secondary battery. In the electric power storage system for home use, electric power accumulated in the secondary battery serving as an electric power storage source may be utilized for using, for example, home appliances.

An application example of the secondary battery will now be described in detail. The configuration of the application example described below is merely an example, and is appropriately modifiable.

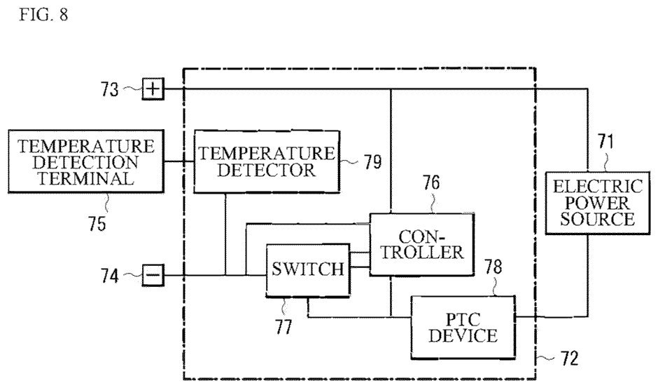

FIG. 8 illustrates a block configuration of a battery pack. The battery pack described here is a battery pack (what is called a soft pack) including one secondary battery, and is to be mounted on, for example, electronic equipment typified by a smartphone.

As illustrated in FIG. 8, the battery pack includes an electric power source 71 and a circuit board 72. The circuit board 72 is coupled to the electric power source 71, and includes a positive electrode terminal 73, a negative electrode terminal 74, and a temperature detection terminal 75.

The electric power source 71 includes one secondary battery. The secondary battery has a positive electrode lead coupled to the positive electrode terminal 73 and a negative electrode lead coupled to the negative electrode terminal 74. The electric power source 71 is couplable to an external power source via the positive electrode terminal 73 and the negative electrode terminal 74, and is thus chargeable and dischargeable with use of the external power source. The circuit board 72 includes a controller 76, a switch 77, a PTC device 78, and a temperature detector 79. However, the PTC device 78 may be omitted.

The controller 76 includes, for example, a central processing unit (CPU) and a memory, and controls an overall operation of the battery pack. The controller 76 detects and controls a use state of the electric power source 71 on an as-needed basis.

If a voltage of the electric power source 71 (the secondary battery) reaches an overcharge detection voltage or an overdischarge detection voltage, the controller 76 turns off the switch 77. This prevents a charging current from flowing into a current path of the electric power source 71. The overcharge detection voltage is not particularly limited, and is specifically 4.20 V±0.05 V. The overdischarge detection voltage is not particularly limited, and is specifically 2.40 V±0.1 V.

The switch 77 includes, for example, a charge control switch, a discharge control switch, a charging diode, and a discharging diode. The switch 77 performs switching between coupling and decoupling between the electric power source 71 and external equipment in accordance with an instruction from the controller 76. The switch 77 includes, for example, a metal-oxide-semiconductor field-effect transistor (MOSFET). The charging and discharging currents are detected based on an ON-resistance of the switch 77.

The temperature detector 79 includes a temperature detection device such as a thermistor. The temperature detector 79 measures a temperature of the electric power source 71 through the temperature detection terminal 75, and outputs a result of the temperature measurement to the controller 76. The result of the temperature measurement to be obtained by the temperature detector 79 is used, for example, when the controller 76 performs charge and discharge control upon abnormal heat generation or when the controller 76 performs a correction process upon calculating a remaining capacity.

### EXAMPLES

A description is given of Examples of the present technology according to an embodiment.

### Examples 1 to 10 and Comparative Examples 1 to 4

Secondary batteries were fabricated, following which the secondary batteries were each evaluated for a battery characteristic.

### [Fabrication of Secondary Battery]

The secondary batteries (the lithium-ion secondary batteries of the laminated-film type) illustrated in FIGS. 1 to 4 were fabricated in accordance with a procedure described below.

### (Fabrication of Positive Electrode)

First, 95 parts by mass of the positive electrode active material (LiNi_{0.8}Co_{0.15}Al_{0.05}O₂ as the lithium-containing compound (an oxide)) including the primary particles 211 and the secondary particles 212, 3 parts by mass of the positive electrode binder (polyvinylidene difluoride), and 2 parts by mass of the positive electrode conductor (Ketjen black as an amorphous carbon powder) were mixed with each other to thereby obtain a positive electrode mixture. In this case, the average particle size D (nm) was set as listed in Table 1.

Thereafter, the positive electrode mixture was put into a solvent (N-methyl-2-pyrrolidone as the organic solvent), following which the organic solvent was stirred to thereby prepare a positive electrode mixture slurry in paste form. Thereafter, the positive electrode mixture slurry was applied on the two opposed surfaces (excluding the positive electrode terminal 31) of the positive electrode current collector 21A (an aluminum foil having a thickness of 10 μm) integrated with the positive electrode terminal 31, by means of a coating apparatus, following which the applied positive electrode mixture slurry was dried to thereby form the positive electrode active material layers 21B. Lastly, the positive electrode active material layers 21B were compression-molded by means of a roll pressing machine. In this manner, the positive electrode 21 was fabricated.

### (Fabrication of Negative Electrode)

First, 95 parts by mass of the negative electrode active material (natural graphite as the carbon material) and 5 parts by mass of the negative electrode binder (polyvinylidene difluoride) were mixed with each other to thereby obtain a negative electrode mixture. Thereafter, the negative electrode mixture was put into a solvent (N-methyl-2-pyrrolidone as the organic solvent), following which the organic solvent was stirred to thereby prepare a negative electrode mixture slurry in paste form. Thereafter, the negative electrode mixture slurry was applied on the two opposed surfaces (excluding the negative electrode terminal 32) of the negative electrode current collector 22A (a copper foil having a thickness of 12 μm) integrated with the negative electrode terminal 32, by means of a coating apparatus, following which the applied negative electrode mixture slurry was dried to thereby form the negative electrode active material layers 22B. Lastly, the negative electrode active material layers 22B were compression-molded by means of a roll pressing machine. In this manner, the negative electrode 22 was fabricated.

### (Fabrication of Separator)

First, 50 parts by mass of the insulating particles 231 (magnesium hydroxide (Mg(OH)₂) as the metal hydroxide having a median diameter D50 of 500 nm) and 50 parts by mass of the separator binder were mixed with each other to thereby obtain a mixture. In this case, the average aspect ratio R and the average length L (nm) were each set as listed in Table 1.

Thereafter, the mixture was put into a solvent (N-methyl-2-pyrrolidone as the organic solvent), following which the solvent was stirred to thereby prepare a slurry in paste form.

Used as the separator binder was a mixture of the homopolymer of vinylidene fluoride (polyvinylidene difluoride) and the copolymer of vinylidene fluoride. Used as the copolymer of vinylidene fluoride was a copolymer of vinylidene fluoride and hexafluoropropylene in which a copolymerization amount of hexafluoropropylene was 34 wt %. In this case, a mixture ratio (a mass ratio) between polyvinylidene difluoride and the copolymer was set to 50:50.

Thereafter, the slurry was applied on one of the two opposed surfaces the porous layer 23A (a fine-porous polyethylene film having a thickness of 10 μm), following which the applied slurry was dried inside a drying furnace to thereby volatilize the solvent. In this manner, the positive electrode side covering layer 23B was formed.

Thereafter, the separator binder was put into a solvent, following which the solvent was stirred to thereby prepare a slurry in paste form. Details of the separator binder were as described above. Thereafter, the slurry was applied on the opposite one of the two opposed surfaces of the porous layer 23A, following which the applied slurry was dried inside the drying furnace to thereby volatilize the solvent. In this manner, the negative electrode side covering layer 23C was formed. As a result, the separator 23 was assembled.

Lastly, as will be described later, in a process of assembling the secondary battery, the outer package film 10 in which the stacked body 20Z was contained was hot-pressed by means of a pressing machine. The positive electrode side covering layer 23B and the negative electrode side covering layer 23C were thereby pressed while being heated. Thus, the positive electrode side covering layer 23B was pressed against the positive electrode active material layer 21B, and the negative electrode side covering layer 23C was pressed against the negative electrode active material layer 22B. As a result, the separator 23 was fabricated.

### (Preparation of Electrolytic Solution)

First, the electrolyte salt (LiPF₆) was put into the solvent (ethylene carbonate as the cyclic carbonic acid ester and propyl propionate as the chain carboxylic acid ester), following which the solvent was stirred. In this case, a mixture ratio (a mass ratio) between ethylene carbonate and propyl propionate in the solvent was set to 50:50, and the content of the electrolyte salt was set to 1 mol/l (=1 mol/dm³) with respect to the solvent. As a result, the electrolytic solution was prepared.

### (Assembly of Secondary Battery)

First, the positive electrodes 21 and the negative electrodes 22 were stacked on each other with the separators 23 each interposed between corresponding one of the positive electrodes 21 and corresponding one of the negative electrodes 22 to thereby fabricate the stacked body 20Z.

Thereafter, the multiple positive electrode terminals 31 were welded to each other to thereby form the joint part 31Z, following which the positive electrode lead 41 (an aluminum plate having a thickness of 1 mm) was welded to the joint part 31Z. Further, the multiple negative electrode terminals 32 were welded to each other to thereby form the joint part 32Z, following which the negative electrode lead 42 (a nickel plate having a thickness of 1 mm) was welded to the joint part 32Z.

Thereafter, the outer package film 10 (the fusion-bonding layer/the metal layer/the surface protective layer) was so folded as to sandwich the stacked body 20Z placed in the depression part 10U. Thereafter, the outer edge parts of two sides of the fusion-bonding layer were thermal-fusion-bonded to each other to thereby allow the stacked body 20Z to be contained in the outer package film 10 having the pouch shape. In this case, the positive electrode lead 41 and the negative electrode lead 42 were each led from the outer package film 10. As the outer package film 10, an aluminum laminated film was used in which the fusion-bonding layer (a polypropylene film having a thickness of 30 μm), the metal layer (an aluminum foil having a thickness of 40 μm), and the surface protective layer (a nylon film having a thickness of 25 μm) were stacked in this order from the inner side.

Thereafter, the electrolytic solution was injected into the outer package film 10 having the pouch shape, following which the outer edge parts of the remaining one side of the fusion-bonding layer were thermal-fusion-bonded to each other in a reduced-pressure environment. In this case, the sealing film 51 (a polypropylene film having a thickness of 5 μm) was interposed between the outer package film 10 and the positive electrode lead 41, and the sealing film 52 (a polypropylene film having a thickness of 5 μm) was interposed between the outer package film 10 and the negative electrode lead 42. Thereafter, the outer package film 10 in which the stacked body 20Z and the electrolytic solution were placed therein was stored (for a storing time of 24 hours).

Lastly, the outer package film 10 in which the stacked body 20Z was contained was hot-pressed by means of a pressing machine including a pair of pressing plates.

The stacked body 20Z was thereby impregnated with the electrolytic solution, and the battery device 20 was thus fabricated. Accordingly, the battery device 20 was sealed in the outer package film 10. As a result, the secondary battery was assembled.

### (Stabilization of Secondary Battery)

The secondary battery was charged and discharged for one cycle in an ambient temperature environment (at a temperature of 25° C.). Upon charging, the secondary battery was charged with a constant current of 0.1 C until a voltage reached 4.2 V, and was thereafter charged with a constant voltage of that value, 4.2 V, until a current reached 0.05 C. Upon discharging, the secondary battery was discharged with a constant current of 0.1 C until the voltage reached 2.5 V. Note that 0.1 C was a value of a current that caused a battery capacity (a theoretical capacity) to be completely discharged in 10 hours, and 0.05 C was a value of a current that caused the battery capacity to be completely discharged in 20 hours.

As a result, a film was formed on the surface of each of the positive electrode 21 and the negative electrode 22, and the secondary battery was thus completed.

After the completion of the secondary battery, the average aspect ratio R, the average particle size D, and the average length L were each examined, and it was confirmed that the average aspect ratio R, the average particle size D, and the average length L were set as listed in Table 1. Thus, the dimensional ratio T was adjusted based on the average particle size D and the average length L.

### [Evaluation of Battery Characteristic]

Evaluation of heating durability and a cyclability characteristic by the following procedure revealed the results presented in Table 1.

### (Heating Durability)

Here, the heating test was performed to thereby examine electrical durability of the secondary battery upon heating of the secondary battery.

Specifically, first, the secondary battery was charged under the above-described charging condition. Specifically, in an ambient temperature environment (at a temperature of 25° C.), the secondary battery was charged with a constant current of 0.2 C until a voltage reached 4.25 V, and was thereafter charged with a constant voltage of that value, 4.25 V, until a total charging time reached 6 hours. Note that 0.2 C was a value of a current that caused the battery capacity to be completely discharged in 5 hours, as described above.

Thereafter, the charged secondary battery was stored (for a storage time of 60 minutes) inside an oven (at a temperature of 130° C.) to thereby heat the secondary battery. In this case, the secondary battery was put inside the oven, and the temperature of the inside of the oven was raised to 130° C. at a heating rate of 5° C./min, following which the storage of the secondary battery was started. Further, an open circuit voltage (OCV (V)) was measured during the storage of the secondary battery to thereby examine a change in the open circuit voltage.

Lastly, based on a voltage drop amount (V) after the storage of the secondary battery, occurrence of a short circuit that was an index for evaluating the heating durability was determined. The voltage drop amount was a parameter indicating how much the open circuit voltage had decreased during the storage with respect to the open circuit voltage of the secondary battery before the storage, and was calculated based on the following calculation expression: voltage drop amount (V)=open circuit voltage (V) before storage-open circuit voltage (V) after storage.

When the voltage drop amount was less than or equal to 250 mV, the voltage drop amount was sufficiently suppressed. It was thus determined that a state where the positive electrode side covering layer 23B was interposed between the positive electrode 21 and the negative electrode 22 was maintained even after the heating test. As a result, the occurrence of a short circuit was sufficiently suppressed, and such a case was thus determined as “A”.

When the voltage drop amount was greater than 250 mV and less than or equal to 350 mV, the voltage drop amount increased but was suppressed within an allowable range. It was thus determined that the state where the positive electrode side covering layer 23B was interposed between the positive electrode 21 and the negative electrode 22 was substantially maintained even after the heating test. As a result, the occurrence of a short circuit was suppressed within an allowable range, and such a case was thus determined as “B”.

When the voltage drop amount was greater than 350 mV, the voltage drop amount excessively increased. It was thus determined that the state where the positive electrode side covering layer 23B was interposed between the positive electrode 21 and the negative electrode 22 was not maintained after the heating test. As a result, a short circuit occurred, and such a case was thus determined as “C”.

### (Cyclability Characteristic)

First, the secondary battery was charged and discharged in an ambient temperature environment (at a temperature of 25° C.) to thereby measure the discharge capacity (a first-cycle discharge capacity).

Upon charging, the secondary battery was charged with a constant current of 1 C until a voltage reached 4.2 V, and was thereafter charged with a constant voltage of that value, 4.2 V, until a current reached 0.01 C. Upon discharging, the secondary battery was discharged with a constant current of 5 C until the voltage reached 2.5 V. Note that 1 C was a value of a current that caused the battery capacity to be completely discharged in 1 hour, 0.01 C was a value of a current that caused the battery capacity to be completely discharged in 100 hours, and 5 C was a value of a current that caused the battery capacity to be completely discharged in 2 hours.

Thereafter, the secondary battery was repeatedly charged and discharged in the same environment until the total number of cycles reached 500 to thereby measure again the discharge capacity (a 500th-cycle discharge capacity). The charging and discharging conditions were as described above.

Lastly, a capacity retention rate that was an index for evaluating the cyclability characteristic was calculated based on the following calculation expression: capacity retention rate (%)=(500th-cycle discharge capacity/first-cycle discharge capacity)×100.

### [Table 1]

TABLE 1

| | Insulating particles | | | | | | |
|---|---|---|---|---|---|---|---|
| | | Average | Average | | | | Capacity |
| | | aspect | particle | Average | Dimensional | | retention |
| | | ratio | size | length | ratio | Determination | rate |
| | Kind | R | D (nm) | L (nm) | T | result | (%) |
| Comparative | Mg(OH)₂ | 2.0 | 335 | 3 | 0.01 | C | 84 |
| example 1 | | | | | | | |
| Comparative | Mg(OH)₂ | 2.0 | 2390 | 287 | 0.12 | A | 70 |
| example 2 | | | | | | | |
| Example 1 | Mg(OH)₂ | 2.0 | 2120 | 460 | 0.22 | A | 74 |
| Example 2 | Mg(OH)₂ | 2.0 | 306 | 95 | 0.31 | A | 85 |
| Comparative | Mg(OH)₂ | 2.0 | 79 | 26 | 0.33 | A | 71 |
| example 3 | | | | | | | |
| Example 3 | Mg(OH)₂ | 2.0 | 100 | 44 | 0.44 | A | 73 |
| Example 4 | Mg(OH)₂ | 2.0 | 400 | 192 | 0.48 | A | 80 |
| Example 5 | Mg(OH)₂ | 2.0 | 1000 | 520 | 0.52 | A | 79 |
| Example 6 | Mg(OH)₂ | 2.0 | 331 | 330 | 1.00 | A | 78 |
| Comparative | Mg(OH)₂ | 2.0 | 287 | 431 | 1.50 | C | 83 |
| example 4 | | | | | | | |
| Example 7 | Mg(OH)₂ | 1.2 | 351 | 123 | 0.35 | B | 81 |
| Example 8 | Mg(OH)₂ | 1.5 | 351 | 153 | 0.44 | A | 82 |
| Example 9 | Mg(OH)₂ | 3.0 | 351 | 158 | 0.45 | A | 83 |
| Example 10 | Mg(OH)₂ | 4.0 | 351 | 289 | 0.82 | B | 81 |

As indicated in Table 1, the occurrence of a short circuit (the determination result) greatly varied depending on the configuration of the separator 23 including the positive electrode side covering layer 23B (the insulating particles 231).

Specifically, when both the appropriate condition related to the average particle size D, i.e., the average particle size D being within the range from 100 nm to 2120 nm both inclusive, and the appropriate condition related to the dimensional ratio T, i.e., the dimensional ratio T being within the range from 0.22 to 1.00 both inclusive, were not satisfied (Comparative examples 1 to 4), a short circuit occurred or the capacity retention rate decreased. In contrast, when the above-described appropriate conditions were satisfied (Examples 1 to 10), a short circuit did not occur and a high capacity retention rate was obtained.

In particular, when the above-described appropriate conditions were satisfied, a series of tendencies described below were obtained.

First, when the average aspect ratio R was within the range from 1.5 to 3.0 both inclusive, the occurrence of a short circuit was further suppressed.

Second, when a state of the insulating particle 231 was checked based on the electron microscope photograph after the heating test by the above-described checking procedure, the insulating particle 231 partially entered the depression 21U and the positive electrode side covering layer 23B entered the gap 21S. As a result, a high capacity retention rate was obtained while the occurrence of a short circuit was suppressed with use of the insulating particle 231.

Here, although a case where the metal hydroxide (magnesium hydroxide) was used as the material included in the insulating particles 231 was specifically tested, a case where each of the metal oxide and the metal nitride was used as the material included in the insulating particles 231 was not specifically tested.

However, each of the metal oxide and the metal nitride is an insulating inorganic material, as with the metal hydroxide. Therefore, also when each of the metal oxide and the metal nitride is used, similar test results as in the case of using the metal hydroxide are expected to be obtained.

Based upon the results presented in Table 1, when: the separator 23 including the porous layer 23A and the positive electrode side covering layer 23B was disposed between the positive electrode 21 and the negative electrode 22; the positive electrode 21 included the primary particles 211 as the positive electrode active material; the positive electrode side covering layer 23B disposed between the porous layer 23A and the positive electrode 21 included the insulating particles 231 each having the major axis J1 and the minor axis J2; the average particle size D was within the range from 100 nm to 2120 nm both inclusive; and the dimensional ratio T was within the range from 0.22 to 1.00 both inclusive, the occurrence of a short circuit was suppressed and a high capacity retention rate was obtained. Accordingly, the heating durability and the cyclability characteristic of the secondary battery improved. It was therefore possible to achieve a superior battery characteristic.

Although the present technology has been described herein including with reference to one or more embodiments including Examples, the configuration of the present technology is not limited thereto, and is therefore modifiable in a variety of ways.

For example, the description has been given of the case where the battery device has a device structure of a stacked type. However, the device structure of the battery device is not particularly limited, and may be of any other type such as a zigzag folded type. In the zigzag folded type, the positive electrode and the negative electrode are opposed to each other with the separator interposed therebetween, and are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode;
a separator disposed between the positive electrode and the negative electrode; and
an electrolytic solution, wherein
the positive electrode includes primary particles as a positive electrode active material,
the separator includes
a porous layer, and
a covering layer disposed between the porous layer and the positive electrode,
the covering layer includes insulating particles, the insulating particles each having a major axis and a minor axis,
an average particle size of the primary particles is greater than or equal to 100 nanometers and less than or equal to 2120 nanometers, and
a ratio of an average length of the respective minor axes of the insulating particles to the average particle size is greater than or equal to 0.22 and less than or equal to 1.00.

2. The secondary battery according to claim 1, wherein one or more of the insulating particles each partially enter a space surrounded by two or more of the primary particles that are adjacent to each other.

3. The secondary battery according to claim 1, wherein an average aspect ratio of the insulating particles defined by the major axis and the minor axis is greater than or equal to 1.5 and less than or equal to 3.0.

4. The secondary battery according to claim 1, wherein the insulating particles each have a flaky shape.

5. The secondary battery according to claim 1, wherein
the positive electrode includes secondary particles, the secondary particles each being an aggregate of the primary particles, and
the covering layer partially enters a space sandwiched between two of the secondary particles that are adjacent to each other.

6. The secondary battery according to claim 5, wherein a thickness of the covering layer in a region in which a portion of the covering layer enters the space is larger than a thickness of the covering layer in a region other than the region in which the portion of the covering layer enters the space.

7. The secondary battery according to claim 1, wherein the covering layer further includes a binder, the binder holding the insulating particles.

8. The secondary battery according to claim 1, wherein the insulating particles each include at least one of a metal hydroxide, a metal oxide, or a metal nitride.

9. The secondary battery according to claim 1, wherein the positive electrode and the negative electrode are alternately stacked on each other with the separator interposed between the positive electrode and the negative electrode.

10. The secondary battery according to claim 9, wherein
the secondary battery further comprises:
a plurality of the positive electrodes;
a plurality of the negative electrodes; and
a plurality of the separators,
the secondary battery further comprises:
positive electrode terminals coupled to the respective positive electrodes; and
negative electrode terminals coupled to the respective negative electrodes,
the positive electrode terminals are joined to each other, and
the negative electrode terminals are joined to each other.

11. The secondary battery according to claim 10, further comprising:
an outer package member having a film shape and containing the positive electrodes, the negative electrodes, the separators, the electrolytic solution, the positive electrode terminals, and the negative electrode terminals;
a positive electrode lead coupled to the positive electrode terminals that are joined to each other; and
a negative electrode lead coupled to the negative electrode terminals that are joined to each other, wherein
the positive electrode lead is led from the outer package member, and
the negative electrode lead is led from the outer package member.

12. The secondary battery according to claim 1, wherein the secondary battery comprises a lithium-ion secondary battery.
